(19) United States
(12) Patent Application Publication
(10) Pub. No.: US 2006/0043857 A1
(43) Pub. Date: Mar. 2, 2006

(54) Flat-type light source and liquid crystal display device having the same

(76) Inventors: Joong-Hyun Kim, Yongin-si (KR); Hae-Il Park, Seoul (KR); In-Sun Hwang, Suwon-si (KR)

Correspondence Address: CANTOR COLBURN, LLP, 55 GRIFFIN ROAD SOUTH, BLOOMFIELD, CT, 06002, US

(21) Appl. No.: 11/217,628

(22) Filed: Sep. 1, 2005

(30) Foreign Application Priority Data
Sep. 2, 2004 (KR) 2004-70003

(51) Int. Cl. H01J 11/00; H01J 65/00; H01J 17/16

(52) U.S. Cl. 313/234; 313/634; 313/317; 313/607

(57) ABSTRACT

In a flat-type light source and an LCD device incorporating the flat-type light source, the flat-type light source includes a lamp body, external electrodes and hollow electrodes. The lamp body has a plurality of discharge spaces. The external electrodes are disposed on an outer surface of the lamp body, and are partially overlapped with the discharge spaces. Each of the hollow electrodes is disposed on an inner surface of the lamp body, and is disposed in each of the discharge spaces. The hollow electrode may have a rectangular or other suitable tube shape. As a result of this construction, a discharge voltage to operate the flat-type light source may be decreased, and discharge efficiency may be increased.

The present application claims priority to Korean Patent Application No. 2004-70003, filed on Sep. 2, 2004, and all the benefits accruing therefrom under 35 USC § 119, the contents of which is hereby incorporated by reference in its entirety.

### BACKGROUND OF THE INVENTION

1. Field of the Invention

The present invention relates to a flat-type light source and a liquid crystal display (LCD) device having the flat-type light source. More particularly, the present invention relates to a flat-type light source capable of generating a planar light from a lamp body having a plurality of discharge spaces, and an LCD device having the flat-type light source.

2. Description of the Related Art

There are a variety of flat panel devices and a liquid crystal display (LCD) device represents one such type of flat panel display devices. The LCD device displays images using liquid crystal. The LCD device has various characteristics, such as, for example, thin thickness, light weight, low driving voltage, low power consumption, etc. Therefore, the LCD device has been widely used in various fields.

The LCD device is a non-emissive type display device so that the LCD device requires a backlight assembly to provide light.

In general, the backlight assembly includes a cold cathode fluorescent lamp (CCFL) as a light source. The backlight assembly (including the CCFL as the light source) is classified either as an edge illumination type backlight assembly or a direct illumination type backlight assembly depending on the position of the light source. One or two lamps of the edge illumination type backlight assembly are positioned on edge portions of a light guide plate to supply light to an LCD panel of the LCD device. A reflecting layer is often provided to the light guide plate to reflect light towards the LCD panel. Lamps of the direct illumination type backlight assembly are positioned under the light guide plate. A reflection plate and a diffusion plate are usually placed under the direct illumination type backlight assembly and on the light guide plate, respectively, to supply the LCD panel with light.

Such conventional backlight assemblies have various characteristics such as low light efficiency, complex structure, high manufacturing cost and non-uniform luminance due to light loss in an associated optical member such as the light guide plate and the diffusion plate.

A flat-type light source has been developed to solve the above-mentioned problems. The flat-type light source includes a lamp body having a plurality of discharge spaces and electrodes for applying a discharge voltage to the lamp body. An inverter applies the discharge voltage to the electrodes so that the flat-type light source generates a plasma discharge in each of the discharge spaces. As a result of this construction, ultraviolet light is generated. The ultraviolet light excites a fluorescent layer on an inner surface of the lamp body so that the fluorescent layer generates visible light. The visible light is then emitted from the lamp body.

In addition, when the discharge spaces are arranged in parallel, the electrode for applying the discharge voltage to the lamp body is positioned on an outer surface of the lamp body and overlapped with the discharge spaces. Therefore, the discharge voltage will increase while the discharge efficiency will decrease.

### SUMMARY OF THE INVENTION

The present invention provides a flat-type light source capable of decreasing a discharge voltage while improving discharge efficiency.

The present invention also provides an LCD device having the above-mentioned flat-type light source.

A flat-type light source in accordance with an exemplary embodiment of the present invention includes a lamp body, a plurality of external electrodes and a plurality of hollow electrodes. The lamp body has a plurality of discharge spaces. The external electrodes are disposed on an outer surface of the lamp body and overlapped with the discharge spaces. The hollow electrodes are disposed on an inner surface of the lamp body at a location corresponding to the external electrodes. In an exemplary embodiment, each of the hollow electrodes is placed respectively on each of the discharge spaces.

The hollow electrode may have a variety of suitable shapes including, for example a U-shape, a rectangular tube shape and/or a hollow cylindrical shape. The hollow electrode is disposed on the inner surface of the lamp body. An adhesive such as, for example, a frit is placed between the hollow electrode and the lamp body.

The lamp body includes a first substrate, a second substrate, a sealing member and a plurality of partitions. The first substrate may have a flat-plate shape. The second substrate may have a shape which is substantially the same as the first substrate, and is spaced apart from the first substrate. The sealing member is disposed at a peripheral portion between the first and second substrates. The sealing member seals the first substrate to the second substrate. The partitions are disposed between the first and second substrates, and divide an inner space of the lamp body into the discharge spaces. The hollow electrodes are disposed on at least one inner surface of the first and second substrates.

Alternatively, the lamp body may include a first substrate and a second substrate. The first substrate may have a flat-plate shape. The second substrate has a plurality of discharge space parts, a plurality of space division parts and a sealing part. The discharge space parts are spaced apart from the first substrate to form the discharge spaces. The space division parts are disposed between adjacent discharge space parts and make contact with the first substrate. The sealing part is placed on a peripheral portion of the space division parts to combine the second substrate with the first substrate. The hollow electrodes are disposed on the inner surface of the first substrate.

An LCD device in accordance with an exemplary embodiment of the present invention includes a flat-type light source, a receiving container, an LCD panel, and an inverter.

The flat-type light source has a lamp body, a plurality of external electrodes and a plurality of hollow electrodes. The lamp body has a plurality of discharge spaces. The external electrodes are disposed on an outer surface of the lamp body, and are overlapped with the discharge spaces. Each of the hollow electrodes is disposed on an inner surface of the lamp body corresponding to the external electrode, and is also disposed on each of the discharge spaces. The receiving container receives the flat-type light source. The LCD panel is placed on an upper part of the flat-type light source, and displays an image by using light generated from the flat-type light source. The inverter is disposed on a rear surface of the receiving container. The inverter generates a discharge voltage to operate the flat-type light source, and applies the discharge voltage to the external electrodes.

In accordance with an exemplary embodiment of the flat-type light source and the LCD device having the flat-type light source, the discharge voltage for operating the flat-type light source may decrease while the discharge efficiency may increase.

### BRIEF DESCRIPTION OF THE DRAWINGS

The above and other advantages of the present invention will become more apparent by describing in detail exemplary embodiments thereof with reference to the accompanying drawings, in which:

FIG. 1 is an exploded perspective view showing a flat-type light source in accordance with an exemplary embodiment of the present invention;

FIG. 2 is a cross-sectional view taken along line I-I′ of FIG. 1;

FIG. 3 is a cross-sectional view taken along line II-II′ of FIG. 1;

FIG. 4 is a perspective view showing a hollow electrode of the type shown in FIG. 1;

FIG. 5 is a perspective view showing another hollow electrode of the type shown in FIG. 1;

FIG. 6 is a perspective view showing still another exemplary hollow electrode of the type shown in FIG. 1;

FIG. 7 is an exploded perspective view showing a flat-type light source in accordance with another exemplary embodiment of the present invention;

FIG. 8 is a cross-sectional view taken along line III-III′ of FIG. 7;

FIG. 9 is an exploded perspective view showing an LCD device in accordance with an exemplary embodiment of the present invention; and

FIG. 10 is a cross-sectional view showing the LCD device show in FIG. 9.

### DETAILED DESCRIPTION OF THE INVENTION

It should be understood that the exemplary embodiments of the present invention described below may be varied and modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the present Invention will be described in detail with reference to the accompanying drawings.

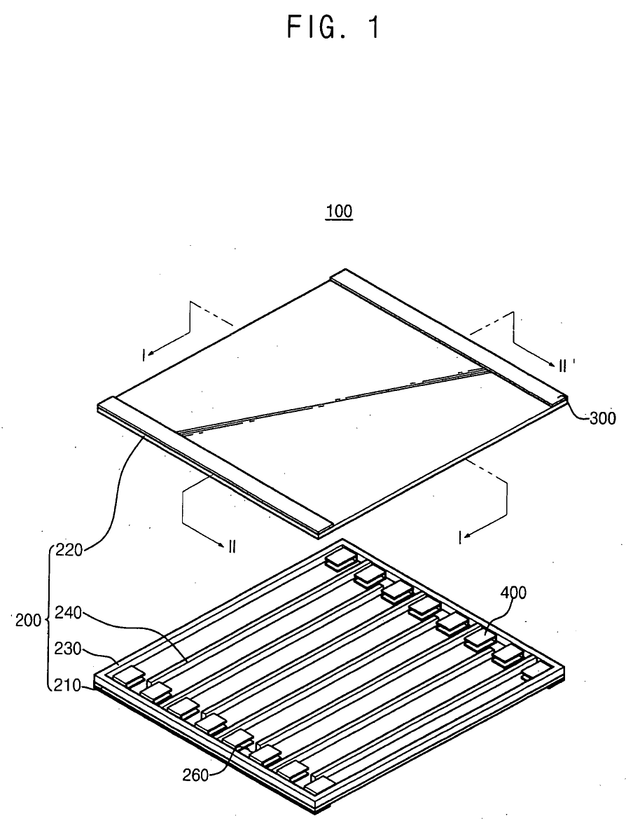

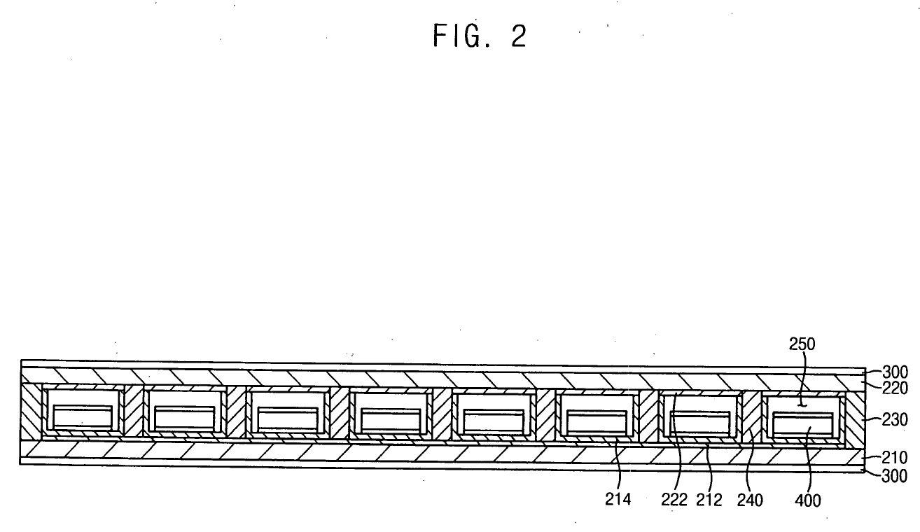

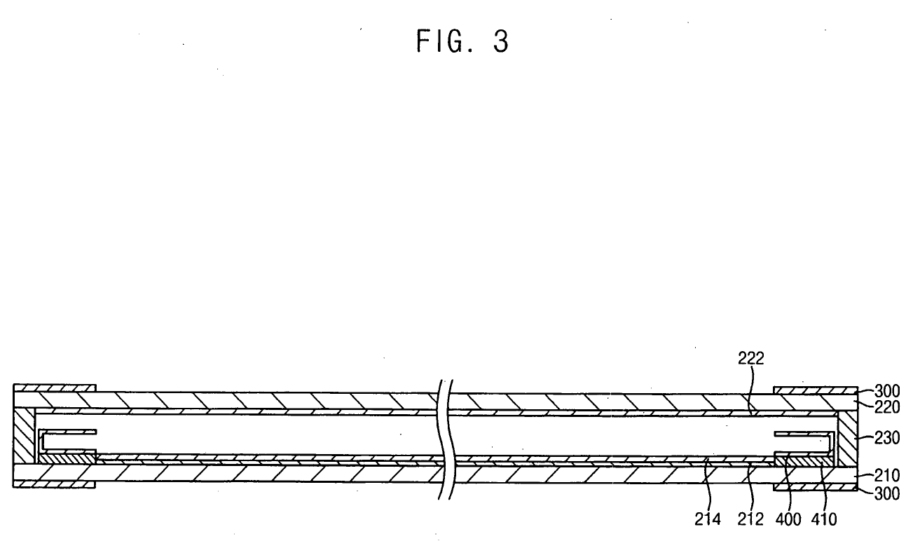

FIG. 1 is an exploded perspective view showing a flat-type light source in accordance with an exemplary embodiment of the present invention. FIG. 2 is a cross-sectional view taken along line I-I′ of FIG. 1. FIG. 3 is a cross-sectional view taken along line II-II′ shown in FIG. 1.

Referring to FIGS. 1 to 3, the flat-type light source 100 includes a lamp body 200, a plurality of external electrodes 300 and a plurality of hollow electrodes 400. The lamp body 200 includes a plurality of discharge spaces 250. Each of the external electrodes 300 is disposed on an outer surface of the lamp body 200. In their embodiment, each external electrode 300 is partially overlapped with the discharge spaces 250. Each of the hollow electrodes 400 is disposed on an inner surface of the lamp body 200 in a location which corresponds to the external electrode 300. Each hollow electrode 400 is also within each of the discharge spaces 250.

The lamp body 200 includes a first substrate 210, a second substrate 220, a sealing member 230 and a plurality of partitions 240.

In an exemplary embodiment, the first substrate 210 has a flat-plate shape and is comprised of, for example, a transparent glass that transmits ultraviolet light. The second substrate 220 has a shape which is substantially the same as the first substrate 210 and is comprised of, for example, the same glass as the first substrate 210. The second substrate 220 is spaced apart from the first substrate 210 to form an inner space. The first and second substrates 220 may include a black matrix of the ultraviolet light in order to prevent a leakage of the ultraviolet light generated in the inner space.

The sealing member 230 is disposed between peripheral portions of the first and second substrates 210 and 220. The sealing member 230 seals the first substrate 210 to the second substrate 220. The sealing member 230 is comprised of, for example, the same glass as the first and the second substrates 210 and 220. The sealing member 230 may be combined with the first and the second substrates 210 and 220 through an adhesive member such as a frit. The frit is a mixture of glass and metal, and has a melting point lower than that of the glass used for the first and second substrates 210 and 220 and the sealing member 230.

At least one partition 240 is disposed between the first and second substrates 210 and 220. Each of the partitions 240 divides the inner space formed between the first and the second substrate 210 and 220 into the discharge spaces 250. The partitions 240 may have a rod or other suitable shape. The partitions 240 are extended in one direction and are substantially parallel to one another. In an exemplary embodiment, each of the intervals between adjacent partitions 240 have the same dimension. Each of the partitions 240 is made of, for example, the same glass as the sealing member 230. The partitions 240 are combined with the first and second substrates 210 and 220 through the adhesive member, such as above-mentioned frit. Alternatively, molten raw material of the partitions 240 is injected into one of the first and second substrates 210 and 220 using a dispenser. The molten raw material in the dispenser is discharged from the dispenser to form the partitions 240 with a desired shape. A cross section of each of the partitions 240 may have, for example, a rectangular shape. Alternatively, the cross section of the partition 240 may have, for example, a trapezoidal shape or a semi-circular shape.

The external electrodes 300 are positioned on opposed end portions, respectively, of the outer surface of the lamp body 200, which are corresponding to opposed end portions of the partitions 240 in their longitudinal direction. Each external electrode 300 is extended in a direction substantially perpendicular to the longitudinal direction of the partitions 240, thereby being overlapped with each of the discharge spaces 250. The external electrodes 300 may be disposed on an upper surface of the second substrate 220. In another embodiment, the external electrodes may be disposed on a lower surface of the first substrate.

In the exemplary embodiment shown in FIGS. 1-3, the external electrodes 300 are positioned on the outer surfaces of the first and second substrates 210 and 220. The external electrodes 300 may be formed, for example, by coating a silver paste comprised of a mixture of silver and silicon oxide. Alternatively, the external electrodes 300 may be formed by spray coating a metallic powder such as Cu, Ni, Ag, Au, Al, Cr, a mixture thereof, etc. on the first and second substrates 210 and 220. A discharge voltage to operate the flat-type light source 100 is applied to the external electrodes 300 from an inverter (not shown).

The hollow electrodes 400 are positioned on the inner surface of the lamp body 200 corresponding to the external electrodes 300. The hollow electrodes 400 are respectively positioned within each of the discharge spaces 250. In an exemplary embodiment, the hollow electrodes 400 are on the upper surface of the first substrate 210. Alternatively, the hollow electrodes 400 may be on the lower surface of the second substrate 220, and the external electrode 300 may be formed on the upper surface of the second substrate 220. The hollow electrodes 400, for example, are attached to the first substrate 210 through an adhesive member 410 such as the aforementioned frit. The hollow electrodes 400 may comprise, for example, Ni or an alloy of Ni and Cr.

In the flat-type light source 100, a capacitance formed by the first substrate 210 and the adhesive member 410 acts as a ballastor so that the discharge spaces 250 may be operated in parallel. Therefore, the discharge voltage of the light source 100 may decrease and the discharge efficiency may increase.

The lamp body 200 further includes a reflective layer 212, a first fluorescent layer 214 and a second fluorescent layer 222.

The reflective layer 212 is disposed on the upper surface of the first substrate 210. The reflective layer 212 may have a thin-film type layer. The reflective layer 212 reflects ultraviolet light generated by the first and second fluorescent layers 214 and 222 toward the second substrate 220 so that any leakage of the ultraviolet light to the first substrate 210 may be prevented and/or effectively reduced. The reflective layer 212 may be made from, for example, a metal oxide to increase a reflectivity and decrease a change of coordinate. For example, the reflective layer 212 may be comprised of aluminum oxide or barium sulfate.

The first fluorescent layer 214 is disposed on the reflective layer 212 and sides of the partitions 240 as a thin-film type layer. The second fluorescent layer 222 is formed on the lower surface of the second substrate 220 also as a thin-film type layer. Therefore, each of the discharge spaces 250 is surrounded by the first and second fluorescent layers 214 and 222. When the ultraviolet light is irradiated onto the first and second fluorescent layers 214 and 222, the first and second fluorescent layers 214 and 222 are excited by the ultraviolet light, thereby generating visible light.

The lamp body 200 may further include a protective layer (not shown) between the second substrate 220 and the second fluorescent layer 222 or between the first substrate 210 and the reflective layer 212. The protective layer prevents a chemical reaction between mercury associated with the discharge gas and the first substrate 210 or between such mercury and the second substrate 220 so that a loss of mercury or blackening phenomenon of the flat-type light source 100 may be prevented or effectively reduced.

The lamp body 200 includes a connection passage 260. The connection passage 260 connects adjacent discharge spaces 250 to each other. At least one longitudinal end portion of each of the partitions 240 is spaced back from the sealing member 230 such that the partition 240 will not contact the sealing member 230 resulting in a gap which thereby forms the connection passage 260. The partitions 240 of this embodiment have a serpentine shape to form the connection passage 260. More particularly, one longitudinal end portion of one of the partitions 240 is spaced apart from the sealing member 230. A longitudinal end portion at the opposite side of a partition 240 that is adjacent to the one of the partitions 240 is also spaced apart from the sealing member 230. Alternatively, both end portions of each of the partitions 240 may be closely sealed by the sealing member 230. The connection passage 260 may then be formed by cutting or drilling a portion of each of the partitions 240 to form the desired interconnection.

Various discharge gases for the plasma discharge are injected into the discharge spaces 250. For example, the discharge gas may include Hg, Ne, Ar, Xe, Kr, a mixture thereof, etc. The discharge gas injected into one of the discharge spaces 250 moves to another of the discharge spaces 250 through the connection passage 260 so that the discharge gas may be uniformly distributed throughout the discharge spaces 250 under a uniform gas pressure.

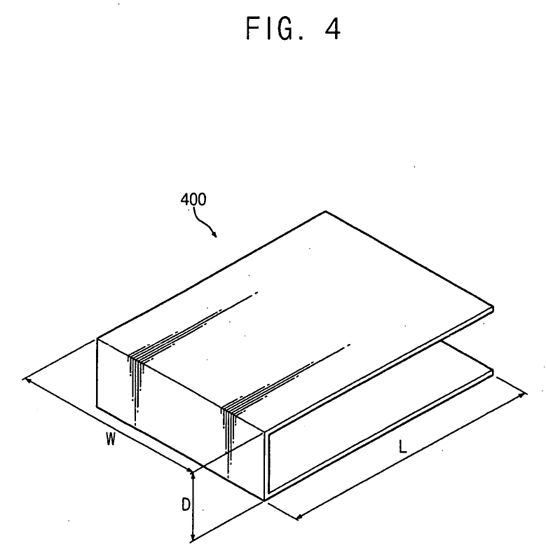

FIG. 4 is a perspective view showing a hollow electrode of the type shown in FIG. 1.

Referring to FIGS. 2 to 4, in an exemplary embodiment, each of the hollow electrodes 400 has a U-shape. The hollow electrodes 400 are disposed at both sides of the respective discharge spaces 250. Both the sides of the respective discharge spaces 250 are corresponding to the external electrodes 300, respectively. The open portion of a hollow electrode 400 that is at one side of a corresponding discharge space 250 is positioned so as to be opposite to the open portion of an associated hollow electrode 400 that is placed on the other side of the discharge space 250. The hollow electrode 400 is, for example, attached to the first substrate 210 through a frit 410 such as the frit described above.

A height of the hollow electrode 400 may satisfy the following Equation 1 (IEEE transactions on electron device, vol. 41, no 4, p504).
P×H=10(Torr×cm) (1)

In Equation 1, P represents a gas pressure of the discharge gas in the discharge space 250, and D represents a height of the hollow electrode 400.

For example, the gas pressure of the discharge gas may be about 50 Torr to about 70 Torr. Therefore, the height D of the hollow electrode 400 may be about 1 mm to about 2 mm to satisfy Equation 1.

When the width of the hollow electrode 400 increases, an electrical characteristic of the hollow electrode 400 is improved. In an exemplary embodiment, the width of the hollow electrode 400 is shorter than the distance between adjacent partitions 240. For example, the width W of the hollow electrode 400 is about 8 mm. Also, a length L of the hollow electrode 400 may be determined based on a length of the external electrode 300. For example, the length L of the hollow electrode 400 may be about 15 mm.

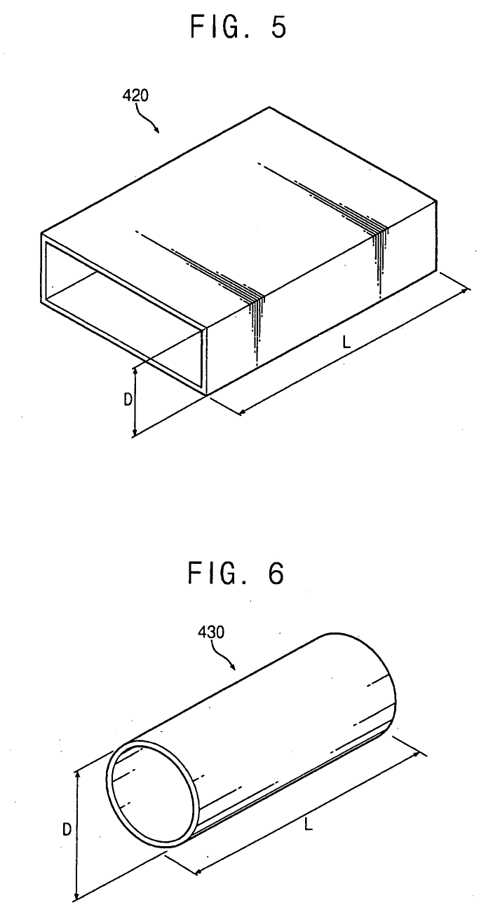

FIG. 5 is a perspective view showing another exemplary hollow electrode shown in FIG. 1.

Referring to FIG. 5, the hollow electrode 420 has a rectangular tube shape. Two corresponding (e.g. facing) surfaces of the six surfaces of the hollow electrode 420 may be open. Alternatively, only one surface of the six surfaces of the hollow electrode 420 may be open. One of the two open corresponding surfaces, which faces one of the discharge spaces 250, is opposite to the other of the two open corresponding surfaces. The hollow electrode 420 is, for example, attached to a first substrate 210 through a frit 410.

For example, the hollow electrode 420 has a height D of about 1 mm to about 2 mm, a width of about 8 mm, and a length of about 15 mm.

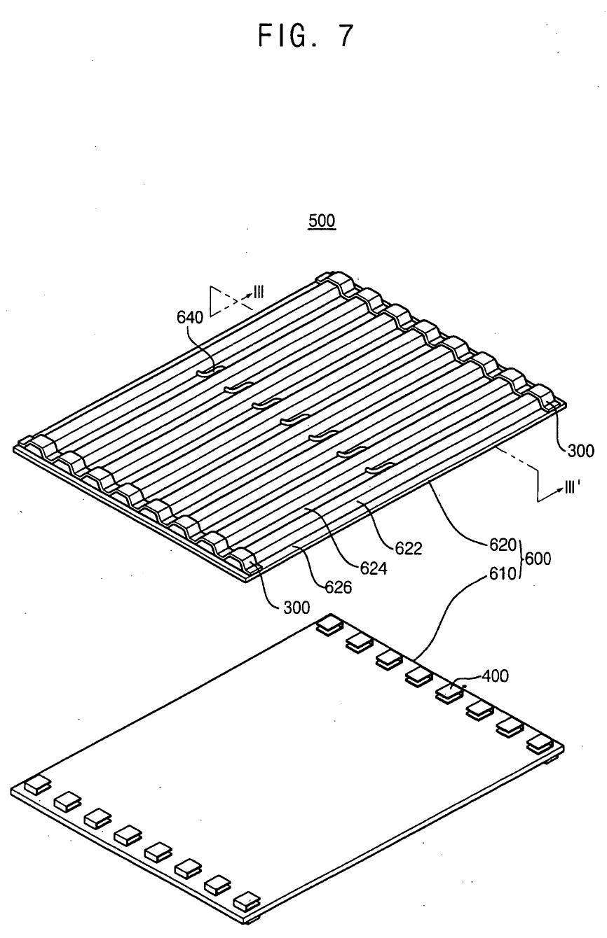

FIG. 6 is a perspective view showing still another exemplary hollow electrode that may be employed in the flat-type light source in FIG. 1.

Referring to FIG. 6, the hollow electrode 430 has a hollow cylindrical shape. Two corresponding surfaces of the hollow electrode 430 (i.e., the two opposed end surfaces) are open. Alternatively, only one of the two corresponding surfaces of the hollow electrode 430 may be open. One of the two open corresponding surfaces, which faces one of the discharge spaces 250, is positioned opposite to the other of the two open corresponding surfaces. The hollow electrode 430 may be attached to a first substrate 210 through a frit 410.

For example, the hollow electrode 430 has a height D of about 1 mm to about 2 mm, and a length of about 15 mm.

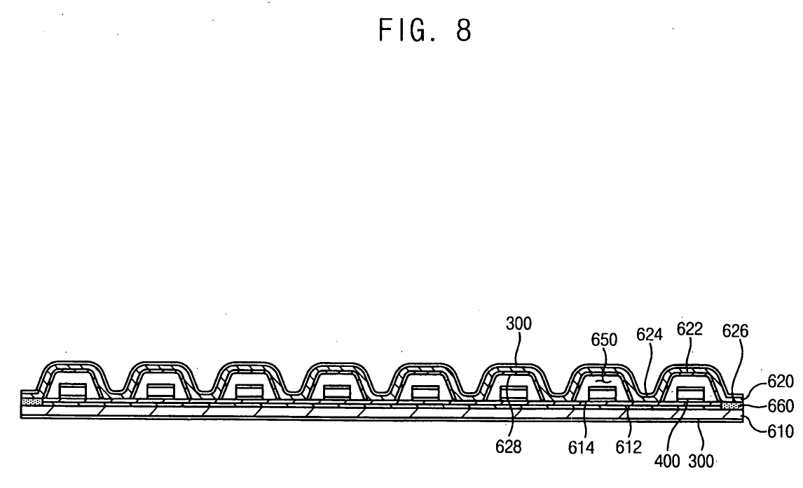

FIG. 7 is an exploded perspective view showing a flat-type light source in accordance with another exemplary embodiment of the present invention. FIG. 8 is a cross-sectional view taken along line III-III′ of FIG. 7. In this exemplary embodiment, the flat-type light source and the hollow electrode shown in FIGS. 7 and 8 are the same as that shown in FIGS. 1 to 6. Thus, the same reference numerals will be used to refer to the same or like parts as those described in FIGS. 1 to 6 and any further explanation will be omitted since such explanation has already been given above.

Referring to FIGS. 7 and 8, the flat-type light source 500 includes a lamp body 600, an external electrode 300 and a hollow electrode 400.

The lamp body 600 has a first substrate 610 and a second substrate 620. In an exemplary embodiment, the first substrate 610 has a flat-plate shape. The second substrate 620 is combined with the first substrate 610 to form a plurality of discharge spaces 650. The first and second substrates 610 and 620 are made of, for example, a transparent glass that transmits visible light.

The second substrate 620 has a plurality of discharge space parts 622, a plurality of space division parts 624 and a sealing part 626. The discharge space parts 622 are spaced apart from the first substrate 610 to form the discharge spaces 650. The space division parts 624 are formed between adjacent discharge space parts 622, and make contact with the first substrate 610. The sealing part 626 is disposed at a peripheral portion of the discharge space parts 622 and the space division parts 624, and is combined with the first substrate 610.

The second substrate 620, for example, is formed through a molding process. In an example of a suitable molding process, a plate-shaped base substrate is heated to a predetermined temperature. The heated plate-shaped base substrate is pressed using a mold to form the discharge space parts 622, the space division parts 624 and the sealing part 626. Alternatively, the second substrate 620 may be formed through various other suitable methods.

As shown in FIG. 8, the second substrate 620 has a plurality of trapezoidal shapes including rounded corners. The trapezoidal shapes are arranged in a straight line substantially parallel with the first substrate 610. Alternatively, the second substrate 620 may have other various, suitable shapes such as, for example, a semi-circular shape, a rectangular shape, etc.

The second substrate 620, for example, is combined with the first substrate 610 through an adhesive member 660 such as a frit. In order to combine the first substrate 610 with the second substrate 620, the adhesive member 660 is interposed between the first and second substrates 610 and 620 at an area corresponding to the sealing part 626. The adhesive member 660 is placed on the sealing part 626 between the first and second substrates 610 and 620. The adhesive member 660, however, does not contact the space division parts 624 that make contact with the first substrate 610. The space division parts 624 make contact with the first substrate 610 by a pressure difference between the discharge spaces 650 and the outside of the lamp body 600. More particularly, after combining the first substrate 610 with the second substrate 620, air in the discharge spaces 650 is exhausted to form a vacuum state. Various discharge gases for a plasma discharge are then injected into the discharge spaces 650. For example, the discharge gas may include Hg, Ne, Ar, Xe, Kr, a mixture thereof, etc. The pressure of the discharge gas in the discharge spaces 650 is about 50 Torr to about 70 Torr, while an atmospheric pressure is 760 Torr. Therefore, a pressure difference is generated between the discharge spaces 650 and the outside of the lamp body 600 so that the space division parts 624 make contact with the first substrate 610.

A connection passage 640 is formed on the second substrate 620 to connect adjacent discharge spaces 650. At least one connection passage 640 is formed on each of the space division parts 624. The discharge gas injected into the discharge spaces 650 is moved from one to another of the discharge spaces 650 through the connection passage 640 so that the discharge gas may be uniformly distributed in discharge spaces 650, thereby providing uniform pressure distribution in the discharge spaces 650.

The lamp body 600 further includes a reflective layer 612 on the first substrate 610, a first fluorescent layer 614 on the reflective layer 612 and a second fluorescent layer 628 on the second substrate 620. When an ultraviolet light is irradiated into the first and second fluorescent layers 614 and 628, the first and second fluorescent layers 614 and 628 are excited by the ultraviolet light, thereby generating visible light. The visible light generated from the first and second fluorescent layers 614 and 628 is reflected from the reflective layer 612 toward the second substrate 620 in order to prevent leakage of the visible light to the first substrate 610.

In an exemplary embodiment, an external electrode 300 is disposed on an outer surface of the lamp body 600 formed by the first and second substrates 610 and 620. Alternatively, the external electrode 300 may be on the lower surface of the first substrate 610. A hollow electrode 400 is attached to an upper surface of the first substrate 610 in a location corresponding to each of the discharge spaces 650. The second substrate 620 may be molded so that the hollow electrode 400 may be attached to an upper surface of the second substrate 620.

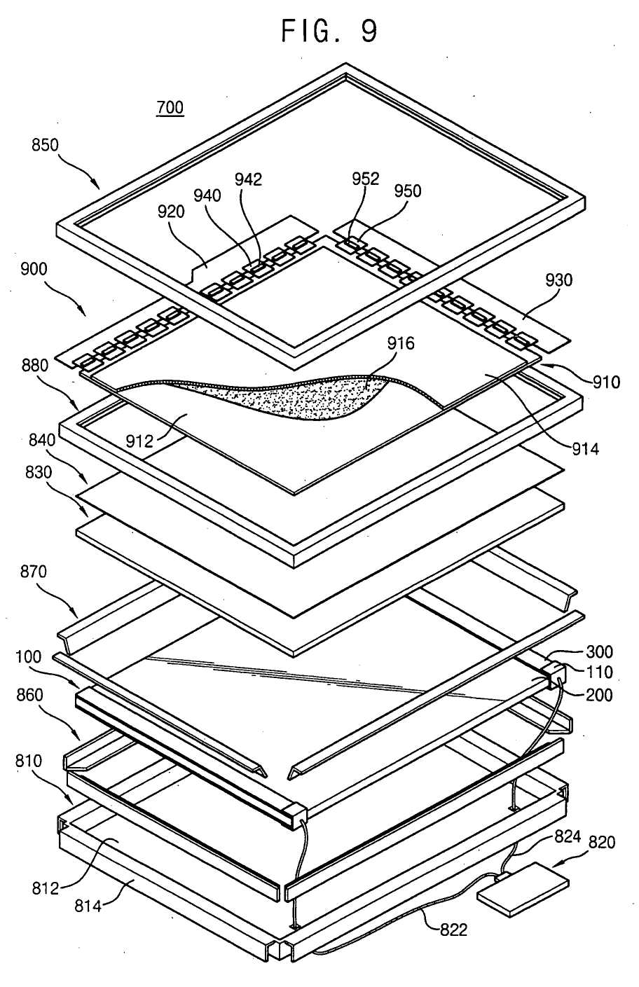

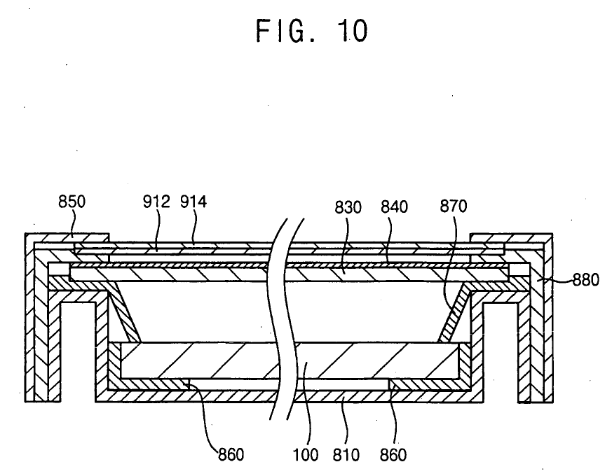

FIG. 9 is an exploded perspective view showing an LCD device in accordance with an exemplary embodiment of the present invention. FIG. 10 is a cross-sectional view showing the LCD device in FIG. 9. In this exemplary embodiment, the flat-type light source shown in FIGS. 9 and 10 is the same as that shown in FIGS. 1 to 8. Thus, the same reference numerals will be used to refer to the same or like parts as those described in FIGS. 1 to 8 and any further explanation will be omitted since such explanation has already been given above.

Referring to FIGS. 9 and 10, the LCD device 700 includes a flat-type light source 100, a receiving container 810, a display unit 900 and an inverter 820.

The receiving container 810 includes a bottom plate 812 and a plurality of side walls 814. The side walls 814 protrude from sides of the bottom plate 812 to form a receiving space. Each of the side walls 814, for example, has an inverted U-shape so that the receiving container 810 is securely combined with, and forms a space to receive there within other elements such as the inverter 820, a supporting member 860, a first mold 870, a top chassis 850, etc., and each of the side walls 814 form a space for the elements. The receiving container 810, for example, is made of metal having excellent strength and relatively small deformation. The flat-type light source 100 is received in the receiving space of the receiving container 810.

The display unit 900 includes an LCD panel 910, a data printed circuit board (PCB) 920, and a gate PCB 930. The LCD panel 910 displays images using light generated from the flat-type light source 100. The data and gate PCBs 920 and 930 generate driving signals to drive the LCD panel 910. Driving signals generated from the data and gate PCBs 920 and 930 are applied to the LCD panel 910 through a data flexible circuit film 940 and a gate flexible circuit film 950. For example, each of the data and gate flexible circuit films 940 and 950 may comprise a tape carrier package (TCP) or a chip on film (COF). Also, the data and gate flexible circuit films 940 and 950 further comprise a data driving chip 942 and a gate driving chip 952 controlling the driving signals, respectively, to apply the driving signals to the LCD panel 910 at a predetermined time.

The LCD panel 910 includes a thin film transistor (TFT) substrate 912, a color filter substrate 914 and liquid crystal 916. The color filter substrate 914 corresponds to the TFT substrate 912. The liquid crystal 916 is disposed between the TFT substrate 912 and the color filter substrate 914.

The TFT substrate 912 has a transparent glass plate, with a plurality of switching elements being arranged in a matrix shape. Each of the switching elements may be in the form of a TFT (not shown) formed on the transparent glass plate. A source electrode (not shown) of the TFT (not shown) is electrically connected to a data line on the transparent glass plate. A gate electrode (not shown) of the TFT (not shown) is electrically connected to a gate line on the transparent glass plate. A drain electrode (not shown) of the TFT (not shown) is electrically connected to a pixel electrode (not shown) on the transparent glass plate.

The color filter substrate 914 includes a transparent plate, a red color filter (not shown), a green color filter (not shown) and a blue color filter (not shown). The red, green and blue color filters (not shown) are formed on the transparent plate through a deposition process, a coating process, a photo process, etc. The common electrode (not shown) is formed on the transparent plate having the red, green and blue color filters (not shown). The common electrode (not shown) includes a transparent conductive material.

When voltages are applied to the gate and source electrodes of the TFT, the TFT is actuated so that an electric field is formed between the pixel electrode (not shown) of the TFT substrate 912 and the common electrode (not shown) of the color filter substrate 914. The molecular arrangement of the liquid crystal 916 is varied in response to the electric field applied thereto, and as a result, a light transmittance of the liquid crystal 916 may be altered, thereby displaying the images.

An inverter 820 is placed on a rear side of the receiving container 810, and generates a discharge voltage to operate the flat-type light source 100. The inverter 820 inverts alternating current voltage that is transmitted from an exterior to the LCD device 700 into a discharge voltage to operate the flat-type light source 100. The discharge voltage generated from the inverter 820 Is applied to external electrodes 300 of the flat-type light source 100 through a first power supply line 822 and a second power supply line 824. The first and second power supply lines 822 and 824 are electrically connected to the external electrodes 300. The external electrodes 300 are formed at end portions of an outer surface of the flat-type light source 100, respectively. When each of the external electrodes 300 is electrically connected to a conductive clip 110, each of the first and second power supply lines 822 and 824 is electrically connected to the conductive clip 110.

The liquid crystal display device 700 further includes an optional diffusion plate 830 and an optical sheet 840. The diffusion plate 830 and the optical sheet 840 are disposed between the flat-type light source 100 and the LCD panel 910. When the light generated from the flat-type light source 100 passes through the diffusion plate 830, the luminance of the light (when viewed in front of the liquid crystal display device 700) increases. In addition, the uniformity of the luminance of the light is increased. In an exemplary embodiment, the diffusion plate 830 has a plate-shape and has a uniform thickness. The diffusion plate 830 is spaced apart from the flat-type light source 100 by a predetermined interval. The optical sheet 840 may further include at least one prism sheet. In the exemplary embodiment, the prism sheet is a brightness enhancement film (BEF). The optical sheet 840 may further include a diffusion sheet (not shown) on or under the prism sheet to diffuse the light. Alternatively, the liquid crystal display device 700 may include an auxiliary optical sheet. It will be appreciated that one or more of the diffusion plate 830, the optical sheet 840, the prism sheet, etc. may be omitted.

The liquid crystal display device 700 may further include the supporting member 860. The supporting member 860 is disposed between the flat-type light source 100 and the receiving container 810 In order to support the flat-type light source 100. The supporting member 860 is disposed at a peripheral portion of the flat-type light source 100. The supporting member 860 allows the flat-type light source 100 to be spaced apart from the receiving container 810 so that an electrical contact between the flat-type light source 100 and the receiving container 810 may be prevented. The supporting member 860 is comprised of an insulating material. In this embodiment, the supporting member 860 is made of a material having elasticity in order to absorb an impact that is provided from an exterior to the liquid crystal display device 700. For example, the supporting member 860 may be made from a silicon.

The liquid crystal display device 700 may further include a first mold 870. The first mold 870 is between the flat-type light source 100 and the diffusion plate 830. The first mold 870 fixes the flat-type light source 100 to the receiving container 810, and supports the diffusion plate 830. The first mold 870 is disposed on the flat-type light source 100 and the sidewalls 814 of the receiving container 810 so as to fix the flat-type light source 100 to the receiving container 810. As shown in the exemplary embodiment in FIG. 9, the first mold 870 has four separate pieces corresponding to four sides of the flat-type light source 100, respectively. Alternatively, the first mold 870 may be divided into two pieces having an L shape or a U shape. Other suitable shapes may also be employed. A plurality of the first molds may be integrally formed to form a mold frame (not shown).

The liquid crystal display device 700 further includes a second mold 880. The second mold 880 is disposed between the optical sheet 840 and the LCD panel 910. The second mold 880 fixes the optical sheet 840 and the diffusion plate 830 to the first mold 870, and supports the LCD panel 910. The second mold 880 may be divided, for example, into two pieces having an L shape or a U shape.

The liquid crystal display device 700 further includes the top chassis 850 to prevent a drifting of the LCD panel 910. That is, the top chassis 850 fixes the LCD panel 910 with respect to the receiving container 810. The top chassis 850 is combined with the receiving container 810 to fix the LCD panel 910 to the second mold 880. The top chassis 850 may protect the LCD panel 910 from an impact that is provided from an exterior to the liquid crystal display device 700.

In accordance with an exemplary embodiment of the present invention, the discharge spaces of the light source may be operated in parallel. A feature of the present invention includes the feature wherein the discharge voltage may be decreased, and the discharge efficiency may be increased.

This invention has been described with reference to the exemplary embodiments. It is evident, however, that many alternative modifications and variations will be apparent to those skilled in the art in light of the foregoing description. Accordingly, the present invention embraces all such alternative modifications and variations as fall within the spirit and scope of the appended claims.

Moreover the use of the terms first, second, etc. do not denote any order or importance, but rather the terms first, second, etc. are used to distinguish one element from another. Furthermore, the use of the terms a, an, etc. do not denote a limitation or quantity, but rather denote the presence of at least one of the referenced item.

What is claimed is:

1. A flat-type light source, comprising:
a lamp body having a plurality of discharge spaces;
a external electrode on an outer surface of the lamp body, the external electrode being overlapped with the discharge spaces; and
a hollow electrode on an inner surface of the lamp body at locations corresponding to the external electrode, the hollow electrode being respectively positioned in the discharge spaces.

2. The flat-type light source of claim 1, wherein the external electrode comprises a plurality of external electrodes, and
the hollow electrode comprises a plurality of hollow electrodes.

3. The flat-type light source of claim 1, wherein the hollow electrode has a U-shape.

4. The flat-type light source of claim 1, wherein the hollow electrode has a U-shape.

5. The flat-type light source of claim 1, wherein the hollow electrode has a rectangular tube shape.

6. The flat-type light source of claim 1, wherein the hollow electrodes has a rectangular tube shape.

7. The flat-type light source of claim 6, wherein the hollow electrode of the rectangular tube shape has at least one open side.

8. The flat-type light source of claim 6, wherein the hollow electrode of the rectangular tube shape has a pair of opposed open sides.

9. The flat-type light source of claim 1, wherein the hollow electrode has a hollow cylindrical shape.

10. The flat-type light source of claim 1, wherein the hollow electrode has a cylindrical shape.

11. The flat-type light source of claim 10, wherein the hollow electrode of the cylindrical shape has at least one open side.

12. The flat-type light source of claim 10, wherein the hollow electrode of the cylindrical shape has a pair of opposed open sides.

13. The flat-type light source of claim 1, wherein the hollow electrode has a height equal to or less than about 2 mm.

14. The flat-type light source of claim 1, wherein the hollow electrode is attached to the inner surface of the lamp body utilizing an adhesive.

15. The flat-type light source of claim 14, wherein the adhesive comprises a frit.

16. The flat-type light source of claim 1, wherein the lamp body comprises:
a first substrate;
a second substrate having substantially same shape as the first substrate, the second substrate being spaced apart from the first substrate;
a sealing member disposed between peripheral portions of the first and second substrates, the sealing member sealing the first substrate to the second substrate; and
a plurality of partitions between the first and second substrates, the partitions forming the discharge spaces.

17. The flat-type light source of claim 16, wherein the first and second substrates have a flat-plate shape.

18. The flat-type light source of claim 16, wherein the external electrode is on at least one of a lower surface of the first substrate and an upper surface of the second substrate.

19. The flat-type light source of claim 16, wherein the hollow electrode is attached to at least one of an upper surface of the first substrate or a lower surface of the second substrate.

20. The flat-type light source of claim 16, wherein adjacent ones of the discharge spaces are interconnected.

21. The flat-type light source of claim 20, wherein the partitions are configured to provide the interconnections.

22. The flat-type light source of claim 1, wherein the lamp body comprises:
a first substrate; and
a second substrate including a plurality of discharge space parts, a plurality of space division parts and a sealing part, the discharge space parts being spaced apart from the first substrate to form the discharge spaces, each of the space division parts being disposed between adjacent ones of the discharge space parts and making contact with the first substrate, and the sealing part being disposed at a peripheral portion of the discharge space parts and the space division parts and attached to the first substrate.

23. The flat-type light source of claim 22, wherein the external electrode is on at least one of a lower surface of the first substrate and an upper surface of the second substrate.

24. The flat-type light source of claim 22, wherein the hollow electrode is attached to an at least one of upper surface of the first substrate and a lower surface of the first substrate.

25. The flat-type light source of claim 1, wherein the lamp body further comprises:
a reflective layer disposed on the inner surface of the lamp body to reflect light; and
a fluorescent layer disposed on the inner surface of the lamp body to surround the discharge spaces.

26. A liquid crystal display device, comprising:
a flat-type light source including:
a lamp body having a plurality of discharge spaces;
a external electrode on an outer surface of the lamp body, the external electrode being partially overlapped with the discharge spaces; and
a hollow electrode attached to an inner surface of the lamp body at locations corresponding to the external electrode, the hollow electrode being disposed on the discharge spaces, respectively;
a receiving container receiving the flat-type light source;
a liquid crystal display panel that displays images using a light generated from the flat-type light source; and
an inverter that generates a discharge voltage to operate the flat-type light source, the inverter applying the discharge voltage to the external electrode.

27. The liquid crystal display device of claim 26, wherein the inverter is positioned on a rear surface of the receiving container.

28. The liquid crystal display device of claim 26, wherein the hollow electrode has a U-shape.

29. The liquid crystal display device of claim 26, wherein the hollow electrode has a rectangular tube shape.

30. The liquid crystal display device of claim 29, wherein the hollow electrode of the rectangular tube shape has at least one open side.

31. The liquid crystal display device of claim 26, wherein the hollow electrode has a hollow cylindrical shape.

32. The liquid crystal display device of claim 31, wherein the hollow electrode of the cylindrical shape has at least one open side.

33. The liquid crystal display device of claim 26, wherein the hollow electrode has a height equal to or less no more than about 2 mm.

34. The liquid crystal display device of claim 26, further comprising:
a diffusion plate disposed between the flat-type light source and the liquid crystal display panel, the diffusion plate diffusing light generated from the flat-type light source;
a brightness enhancement film on the diffusion plate, the brightness enhancement film increasing luminance of the light; and
a top chassis combined with the receiving container, the top chassis fixing the liquid crystal display panel with respect to the receiving container.

35. The liquid crystal display device of claim 34, further comprising:
a supporting member disposed between the flat-type light source and the receiving container, the supporting member supporting the flat-type light source;
a first mold disposed between the flat-type light source and the diffusion plate, the first mold fixing the flat-type light source to the receiving container and supporting the diffusion plate; and
a second mold disposed between the brightness enhancement film and the liquid crystal display panel, the second mold fixing the diffusion plate and the brightness enhancement film to the first mold and supports the liquid crystal display panel.
